(19) United States
(12) Patent Application Publication
(10) Pub. No.: US 2011/0256505 A1
(43) Pub. Date: Oct. 20, 2011

(54) ULTRASONIC TIPS

(76) Inventor: L. Stephen Buchanan, Santa Barbara, CA (US)

(21) Appl. No.: 13/088,263

(22) Filed: Apr. 15, 2011

Related U.S. Application Data
(60) Provisional application No. 61/324,681, filed on Apr. 15, 2010.

(51) Int. Cl. A61C 3/06

(52) U.S. Cl. 433/166

(57) ABSTRACT

An ultrasonic tip for use in dental procedures comprising a hub portion, a tip portion and an intermediate portion, the tip having one or more bends between the hub and the tip, the one or more bends providing an offset of the tip from the location of the hub.

This application claims benefit of U.S. Provisional Application 61/324,681 filed Apr. 15, 2010.

### BACKGROUND OF THE INVENTION

This invention relates to ultrasonic dental tools or instruments, and more particularly to ultrasonic instruments or tips. When installed on an ultrasonic handpiece and energized with ultrasonic energy the tips resonate. The vibrating tip, when brought into working contact with tooth structure, will abrade the contacted tooth surface removing contacted tooth structure or coatings on the tooth (such as in a cleaning procedure) in a controlled fashion. While the vibrating tip can be used for tooth cleaning, they are also useful in preparing the canal of a tooth during root canal and surgical endodontic procedures.

In performing conventional and surgical endodontic procedures it is important for the clinician to have visibility of the canal with the instrument in operation, particularly when performing root canals deep within molar root structure in molar surgery. Prior art ultrasonic instruments have, in the past, provided improved visibility over rotary driven instruments (e.g., burs) because the high speed rotary handpiece head driving the bur is eliminated, thus opening up the field of view into the canal and of the visualization of the working end of the ultrasonic tip. Typical tips are straight which still obstructs the view. There is still a need for better visibility while using ultrasonic tips, particularly when the cutting tip of the instrument is deep in the canal or during apical root end surgery.

### SUMMARY OF THE INVENTION

The objects and features of the present invention include, but are not limited to, the provision of a series of ultrasonic tips with and without diamond coatings for use with an ultrasonic dental handpiece which, when activated, can be efficiently used to eliminate tooth structure for the purpose of treating teeth from a retrograde surgical approach.

The provision of such tips permits the practitioner to readily use slot formation procedures and, for example, place material into the root to seal it to prevent infection within the root from spreading.

The provision of such tips permits the practitioner to flatten the root ends after the tips have been cut off.

The provision of such tips permits the practitioner to smooth the flattened root ends after they have been removed.

The provision of such tips allows the practitioner to use them as a plug to fit in and match the size of the slot preparation in a system-based approach.

### BRIEF DESCRIPTION OF THE DRAWINGS

FIG. 1 is a side view of an ultrasonic tip incorporating features of the invention.

FIG. 2 is an end view of the ultrasonic tip of FIG. 1.

FIG. 3 is a side view of a second embodiment of an ultrasonic tip incorporating features of the invention.

FIG. 4 is an end view of the ultrasonic tip of FIG. 3.

FIG. 5 is a side view of a third embodiment of an ultrasonic tip incorporating features of the invention.

FIG. 6 is an end view of the ultrasonic tip of FIG. 5.

FIG. 7 is a side view of a fourth embodiment of an ultrasonic tip incorporating features of the invention.

FIG. 8 is an end view of the ultrasonic tip of FIG. 7.

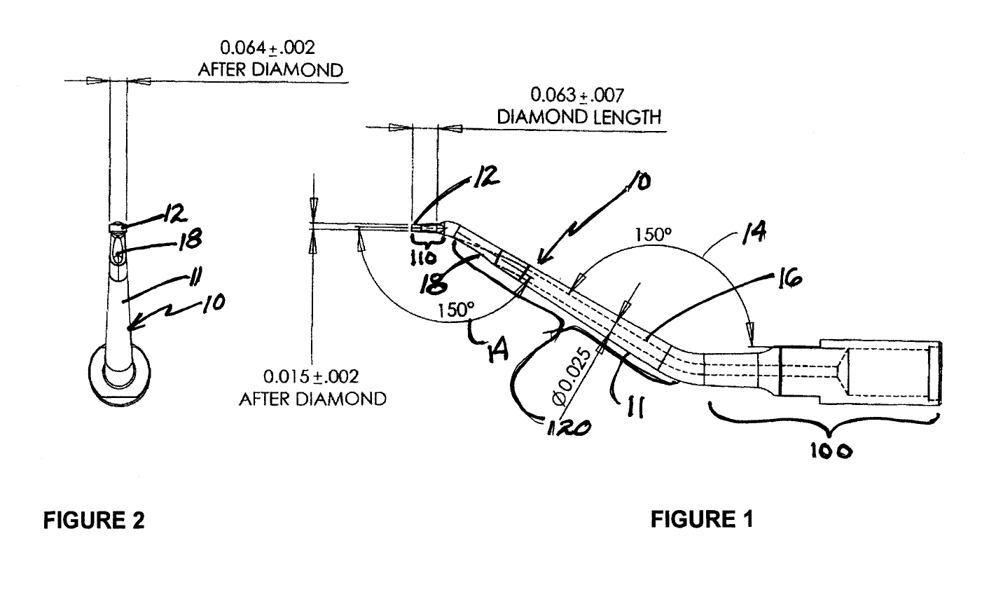

The ultrasonic tip illustrated in FIGS. 1-8 has a flow channel through the center thereof, said flow channel shown in dotted lines on each of the Figures.

### DETAILED DESCRIPTION

The figures show four different embodiments of an ultrasonic tool 10, 20, 30, 40, each with different body angular configurations, and two different shaped tips, namely hatchet tips and paddle tips. The tips can be provided with or without added abrasive coatings, such as a diamond coating or other common abrasive coatings used on ultrasonic tips. One skilled in the art will recognize that the hatchet or paddle tip structures disclosed can be used on any of the disclosed angular bodies. Further, one skilled in the art will recognize that other tips, including standard tips, can be incorporated into the angular body, for example pointed tips, rounded tips or ball tips, which can, for example, be used to form or compress filling materials or polish surfaces abraded by the ultrasonic tips.

The various embodiments of the ultrasonic tool, each of which incorporate features of the invention, have a hub portion 100 for attachment to an ultrasonic handle (not shown), a tip portion 110, also referred to as the working end, and an intermediate portion 120 between the hub portion and the working end, the portions of FIGS. 1 and 2 show a straight approach ultrasonic tip 10 with the body 11 thereof having two intermediate opposite and equal offset angles 12, shown to be 150°, and a paddle tip 14. The 150° off set angle is merely representative and smaller or greater angles, for example 90° to about 170° can be used. The dimensions shown thereon are representative of a tip having a diamond coating. An uncoated tip would have a slightly smaller dimension. A central channel 16 extending longitudinally through the tip with distal opening 18 adjacent the paddle tip is provided for irrigation purpose or using the tip with water to reduce heat and improve visibility. In the straight approach ultrasonic tip, an axis through a central bore in the hub portion 100 is substantially parallel to an axis through a central bore in the working tip 120.

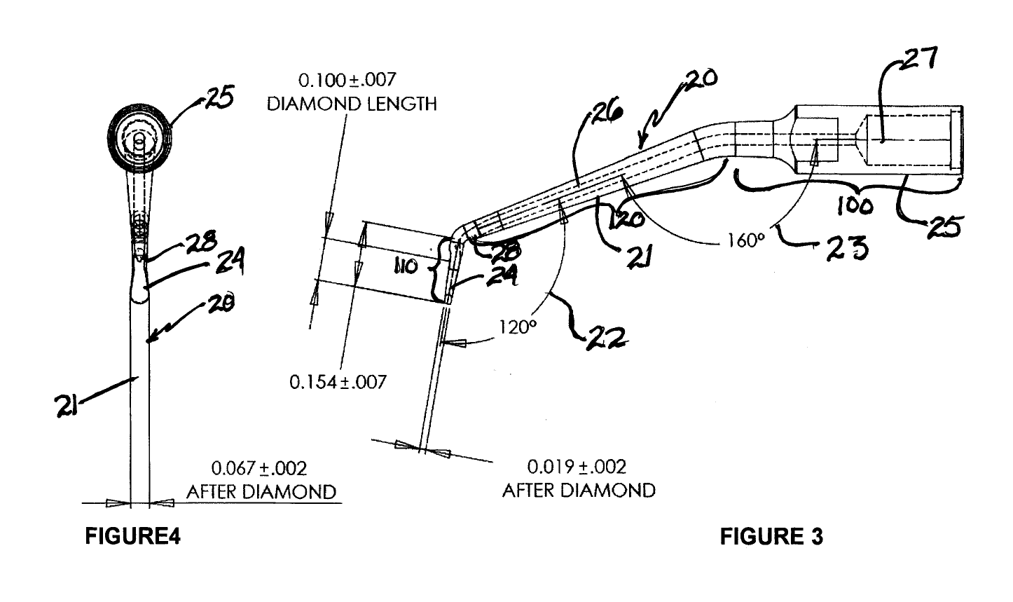

FIGS. 3 and 4 show a first angle approach ultrasonic tip 20 with the body 21 thereof having first and second intermediate and additive offset angles 22, 23, shown to be 160° and 120° from the central axis, providing the bend at the hub is 20°; the bend at the tip is 60° for a total bend of 80° from a central axis 27 through the hub 25. The ultrasonic tip 20 is also shown with a paddle tip 24. The individual angles and the total 60° off set is merely representative and smaller or greater intermediate and total angles, for example 30° to about 150° can be used. The dimensions shown thereon are representative of a tip having a diamond coating. A central channel 26 extending longitudinally through the tip with distal opening 28 adjacent the paddle tip 24 is provided for irrigation purpose or using the tip with water to reduce heat and improve visibility.

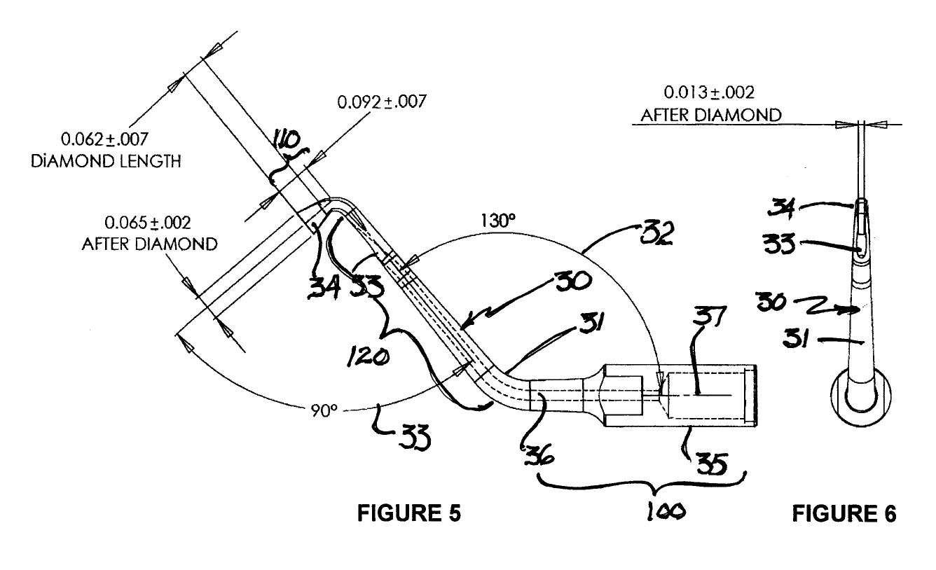

FIGS. 5 and 6 show a second angled approach ultrasonic tip 30 with the body 31 thereof having first and second intermediate additive offsetting angles 32, 33, shown to be 130° and 90° from the central axis. The bend at the hub is 50°; the bend at the tip is 90° for a total bend of 140° from a central axis 37 through the hub 35. The ultrasonic tip 30 is also shown with a hatchet tip 34. The 130° off set angle as well as the additive offsetting angles 32, 33 are merely representative and smaller or greater intermediate and total angles, for example a total offset angle of 90° to about 170° can be used. The dimensions shown thereon are representative of a tip having a diamond coating. A central channel 36 extending longitudinally through the tip with distal opening 38 adjacent the hatchet tip 34 is provided for irrigation purpose or using the tip with water to reduce heat and improve visibility.

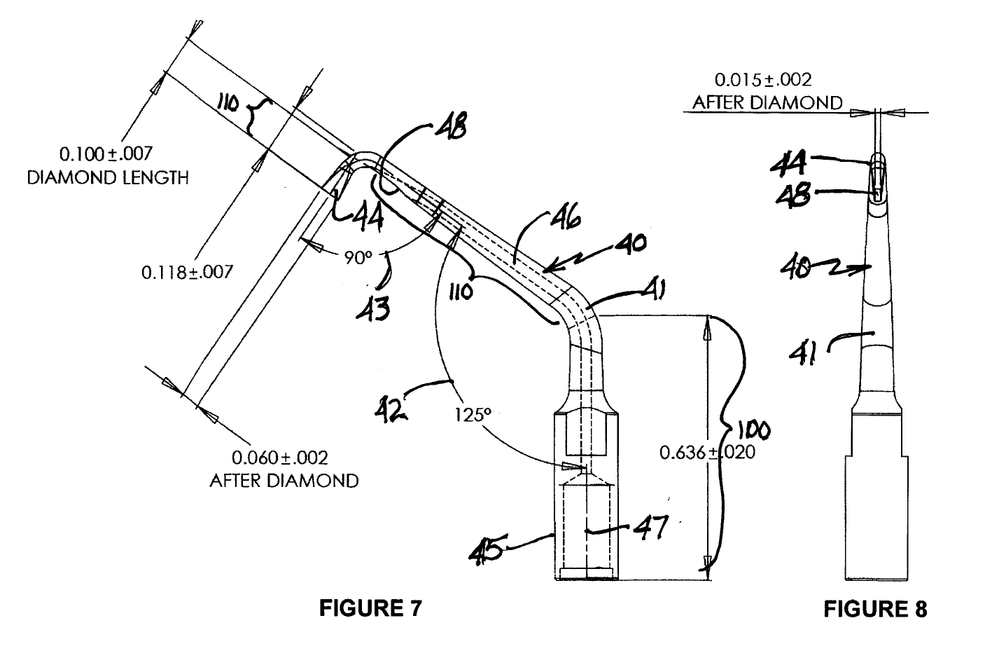

FIGS. 7 and 8 show a third angled approach ultrasonic tip 40 with the body 41 thereof having first and second intermediate and additive offset angles 42, 43 shown to be 90° and 125° from the central axis, providing a total body bend outer angle of 325° (35° inner angle) from a central axis 47 through the hub 45. The bend at the hub is 55°; the bend at the tip is 90° for a total bend of 145°. The ultrasonic tip 40 is also shown with a hatchet tip 44. The individual angles and the total off set are merely representative and smaller or greater angles, for example an outer angle of 270° to about 350° can be used. The dimensions shown thereon are representative of a tip having a diamond coating. A central channel 46 extending longitudinally through the tip with distal opening 48 adjacent the hatchet tip 44 is provided for irrigation purpose or using the tip with water to reduce heat and improve visibility.

The hatchet or paddle tips are particularly suited for preparing slots in broad roots having multiple canals for the purpose of placing a retroseal at the end of the root to prevent infection residing in the root from leaking outside the tooth. The hatchet and paddle tips comprising the working end are shown to be integral with the remainder of the ultrasonic tip to provide a single structure. However, one skilled in the art will recognize that the working end can be provided as a removable end portion, for example attached by a threaded connection, so that alternative working ends can be provided on the same angled ultrasonic tip. The various angled embodiments provide the user with the ability to address a broad range of root angulations as well as to treat teeth at any location in the mouth. However, one skilled in the art based on the teachings herein will recognize that various intermediate angles, to provide various total offsets can be provided. Further, while the embodiments are shown to incorporate two angles, additional angles or smooth arcs or bends can be used to accomplish the same intent. Further, while the angles shown herein are along a single plane, it is also contemplated that compound angles or additional angles can be used so that the operative end of the ultrasonic tip can be rotated from the plane of the body of the tip.

The uncoated tips can be used as pluggers in a system-based approach to match the geometry of the slightly larger cutting diamond coated hatchet tip.

Flattened paddle like ultrasonic tips can be used for flattening and smoothing the cut root surface in preparation for retroseal preparation and to fill angulations.

I claim:

1. An ultrasonic tip for application to an ultrasonic tool for use in dental procedures, said ultrasonic tip comprising a hub portion, a tip portion and an intermediate portion, the tip having at least a first bend at a juncture of the hub portion and the intermediate portion and at least a second bend at a juncture of the tip portion and intermediate portion.

2. The ultrasonic tip of claim 1 further including a lumen extending through the ultrasonic tip from the hub portion through the intermediate portion to a point adjacent to the tip portion for delivering or removing fluids through said ultrasonic tip.

3. The ultrasonic tip of claim 1 wherein the combination of the first bend and the second bend provides an offset from an axis through the center of the hub portion, the axis through the center of the hub portion and an axis through the center of the tip portion being substantially parallel.

4. The ultrasonic tip of claim 1 wherein the combination of the first bend and the second bend provides an offset from an axis through the center of the hub portion said offset being from about 30° to 170°.

5. The ultrasonic tip of claim 1 wherein the combination of the first bend and the second bend provides an offset from an axis through the center of the hub portion said offset being from about 30° to 150°.

6. The ultrasonic tip of claim 1 wherein the combination of the first bend and the second bend provides an offset from an axis through the center of the hub portion said offset being from about 90° to 170°.

7. The ultrasonic tip of claim 1 wherein the combination of the first bend and the second bend provides an offset from an axis through the center of the hub portion said offset being about 80°.

8. The ultrasonic tip of claim 1 wherein the combination of the first bend and the second bend provides an offset from an axis through the center of the hub portion said offset being about 140 to 145°.

9. The ultrasonic tip of claim 1 wherein the tip portion is a paddle tip or hatchet tip.

10. The ultrasonic tip of claim 1 wherein the tip portion has an abrasive material bonded thereto.

11. The ultrasonic tip of claim 10 wherein the abrasive material bonded thereto comprises diamond particles.

12. An ultrasonic tip for use in dental procedures, said ultrasonic tip comprising a hub portion and a tip, the ultrasonic tip having one or more bends along its length between the hub portion and the tip portion said bends providing the tip at an offset from the axis of the hub.

13. The ultrasonic tip of claim 12 further including a lumen extending through the ultrasonic tip from the hub portion to a point adjacent to the tip portion for delivering or removing fluids through said ultrasonic tip.
